(19) United States
(12) Patent Application Publication
(10) Pub. No.: US 2023/0153393 A1
(43) Pub. Date: May 18, 2023

(54) PARAMETER OPTIMIZATION METHOD, NON-TRANSITORY RECORDING MEDIUM, FEATURE AMOUNT EXTRACTION METHOD, AND PARAMETER OPTIMIZATION DEVICE

(71) Applicant: NIPPON TELEGRAPH AND TELEPHONE CORPORATION, Tokyo (JP)

(72) Inventors: Shinobu KUDO, Musashino-shi (JP); Ryuichi TANIDA, Musashino-shi (JP); Hideaki KIMATA, Musashino-shi (JP)

(73) Assignee: NIPPON TELEGRAPH AND TELEPHONE CORPORATION, Tokyo (JP)

(21) Appl. No.: 17/918,173

(22) PCT Filed: Apr. 23, 2020
(86) PCT No.: PCT/JP2020/017502

§ 371 Date: Oct. 11, 2022

(51) Int. Cl. G06F 18/2413; G06F 18/2431

(52) U.S. Cl. CPC G06F 18/24147; G06F 18/2431

(57) ABSTRACT

A parameter optimization method includes extracting a feature vector using input data, acquiring a classification result of the feature vector and a class representative vector of every class serving as a classification target, and optimizing a parameter used in the extracting based on a classification error obtained using correct answer data and the classification result and a distance error between the class representative vectors such that areas of features of the classes in a feature space do not overlap each other.

### TECHNICAL FIELD

The present disclosure relates to a parameter optimization method, a non-transitory recording medium, a feature extraction method, and a parameter optimization apparatus.

### BACKGROUND ART

Various learning techniques have been proposed for individual identification such as facial recognition (e.g., see NPL 1 to NPL 3). L2-Constrained Softmax Loss disclosed in NPL 1, ArcFace disclosed in NPL 2, and AdaCos disclosed in NPL 3 are all techniques in which a feature vector immediately before processing of Softmax is projected on a hypersphere and optimization is performed using a cosine similarity between the feature vector and a class representative vector. For example, ArcFace is a technique for optimization in which an angle between a feature vector and a representative vector of a target class is penalized so that the feature vector is mapped closer to the target class than to other classes. In addition, for example, AdaCos is a version of ArcFace in which parameters are automatically adjusted.

### CITATION LIST

### Non Patent Literature

NPL 1: Rajeev Ranjan, Carlos D. Castillo, Rama Chellappa, “L2-Constrained Softmax Loss for Discriminative Face Verification”, Computer Vision and Pattern Recognition.
NPL 2: Jiankang Deng, Jia Guo, Niannan Xue, Stefanos Zafeiriou, “ArcFace: Additive Angular Margin Loss for Deep Face Recognition”, Computer Vision and Pattern Recognition.
NPL 3: Xiao Zhang, Rui Zhao, Yu Qiao, Xiaogang Wang, Hongsheng Li, “AdaCos: Adaptively Scaling Cosine Logits for Effectively Learning Deep Face Representations”, Computer Vision and Pattern Recognition.

### SUMMARY OF THE INVENTION

### Technical Problem

However, two challenges arise in the above-described techniques of the related art. The first challenge is that class representative vectors of similar samples are mapped to close positions on the hypersphere. As a result, vectors are likely to be classified into wrong classes. The second challenge is that the hypersphere is not fully used. This degrades the expression ability of the feature space, which hinders efficient learning. Both of these challenges lead to degradation of classification accuracy.

In view of the above circumstances, an object of the present disclosure is to provide a technique capable of improving classification accuracy.

### Means for Solving the Problem

An aspect of the present disclosure is a parameter optimization method including extracting a feature vector using input data, acquiring a classification result of the feature vector and a class representative vector of every class serving as a classification target, and optimizing a parameter used in the extracting based on a classification error obtained using correct answer data and the classification result and a distance error between the class representative vectors such that areas of features of the classes in a feature space do not overlap each other.

An aspect of the present disclosure is a non-transitory recording medium configured to record a computer program for causing a computer to execute the parameter optimization method.

An aspect of the present disclosure is a parameter optimization apparatus including a feature extraction unit that extracts a feature vector using input data, a classification unit that acquires a classification result of the feature vector and a class representative vector of every class serving as a classification target, and an optimization unit that optimizes a parameter used in the feature extraction unit based on a classification error obtained using correct answer data and the classification result and a distance error between the class representative vectors such that areas of features of the classes in a feature space do not overlap each other.

An aspect of the present disclosure is a parameter optimization method including extracting a feature vector using input data, acquiring a classification result of the feature vector and a class representative vector of every class serving as a classification target, and optimizing a parameter used in the extracting based on a classification error obtained using correct answer data and the classification result and a distance error between the class representative vectors, and in the optimizing, a position of the class representative vector of every class in the feature space is determined and then the classification error is optimized using a gradient method, so that the parameter is optimized.

An aspect of the present disclosure is a parameter optimization method including extracting a feature vector using input data, acquiring a classification result of the feature vector and a class representative vector of every class serving as a classification target, and optimizing a parameter used in the extracting based on a classification error obtained using correct answer data and the classification result and a distance error between the class representative vectors, and, in the optimizing, the distance error between the class representative vectors is applied to the classification error and optimization is performed using a gradient method, so that the parameter is optimized.

### Effects of the Invention

According to the present disclosure, classification accuracy can be improved.

### BRIEF DESCRIPTION OF DRAWINGS

FIG. 1 is a block diagram illustrating a specific example of a functional configuration of a parameter optimization apparatus according to the present disclosure.

FIG. 2 is a flowchart illustrating processing of the parameter optimization apparatus according to the embodiment.

FIG. 3 is a graph showing a test result when a technique of the related art is used.

FIG. 4 is graphs showing a test result when a technique of the related art is used.

FIG. 5 is a graph showing a test result when a technique of the related art is used.

FIG. 6 is graphs showing a test result when a technique of the related art is used.

FIG. 7 is a graph showing a test result when the technique of the present disclosure is combined with a technique of the related art.

FIG. 8 is graphs showing a test result when the technique of the present disclosure is combined with a technique of the related art.

FIG. 9 is a graph showing a test result when the technique of the present disclosure is combined with a technique of the related art.

FIG. 10 is graphs showing a test result when the technique of the present disclosure is combined with a technique of the related art.

FIG. 11 is a graph showing a test result when the technique of the present disclosure is combined with a technique of the related art.

FIG. 12 is graphs showing a test result when the technique of the present disclosure is combined with a technique of the related art.

FIG. 13 is a graph showing a test result when the technique of the present disclosure is combined with a technique of the related art.

FIG. 14 is a graph showing a test result when the technique of the present disclosure is combined with a technique of the related art.

### DESCRIPTION OF EMBODIMENTS

Embodiments of the present disclosure will be described below with reference to the drawings.

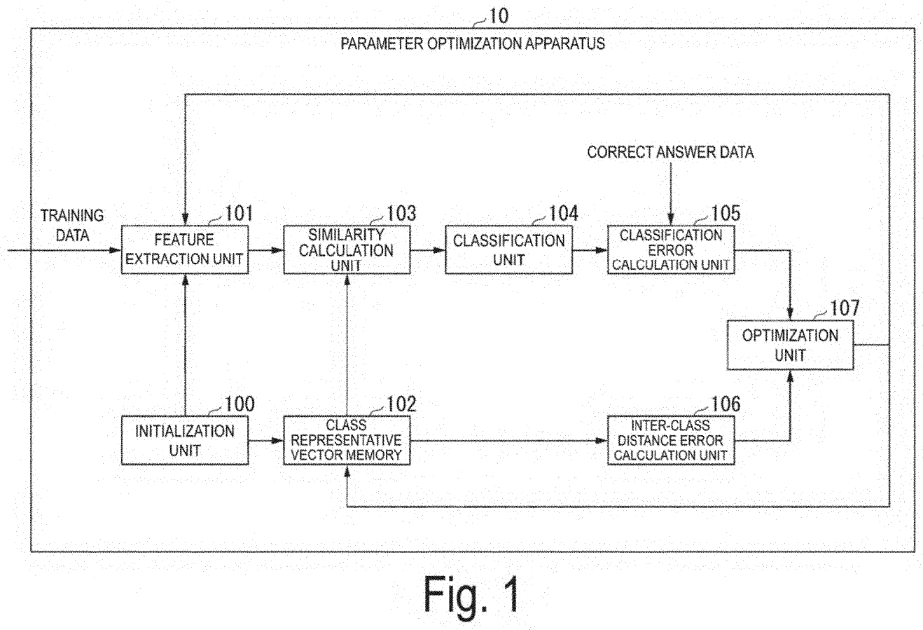

FIG. 1 is a block diagram illustrating a specific example of a functional configuration of a parameter optimization apparatus 10 according to the present disclosure.

The parameter optimization apparatus 10 optimizes parameters for extracting feature vectors used in deep learning. Examples of deep learning to be used in the present embodiment include L2-Constrained Softmax Loss, ArcFace, AdaCos, SphereFace, and CosFace. The parameter optimization apparatus 10 is configured with an information processing apparatus, for example, a personal computer.

The parameter optimization apparatus 10 includes an initialization unit 100, a feature extraction unit 101, a class representative vector memory 102, a similarity calculation unit 103, a classification unit 104, a classification error calculation unit 105, an inter-class distance error calculation unit 106, and an optimization unit 107. The initialization unit 100 initializes information of parameters that the feature extraction unit 101 uses to extract feature vectors and class representative vectors stored in the class representative vector memory 102 into random values.

The feature extraction unit 101 extracts a feature vector using image data input from the outside. For example, at the time of learning, the feature extraction unit 101 extracts feature vectors using input image data for learning. For example, at the time of actual use in processing, the feature extraction unit 101 extracts feature vectors using input image data. Parameters that the feature extraction unit 101 uses to extract feature vectors are initialized into random values at the beginning of the learning processing. At the time of actual use in processing, optimized parameters are used.

The class representative vector memory 102 stores information of class representative vectors. The information of the class representative vectors stored in the class representative vector memory 102 is initialized into random values at the beginning of the learning processing. A class representative vector represents a reference feature vector of each class.

The similarity calculation unit 103 calculates each of the similarities between feature vectors output from the feature extraction unit 101 and class representative vectors stored in the class representative vector memory 102.

The classification unit 104 acquires a classification result of the feature vector output from the feature extraction unit 101 using a softmax function and the value of each similarity calculated by the similarity calculation unit 103. For example, the classification unit 104 acquires the probability of the feature vector output from the feature extraction unit 101 belonging to each class as the classification result.

The classification error calculation unit 105 calculates the classification error based on the classification result acquired by the classification unit 104 and information of the correct answer data input from the outside.

The inter-class distance error calculation unit 106 calculates the error in the distance between the class representative vectors stored in the class representative vector memory 102 (hereinafter referred to as an “inter-class distance error”).

The optimization unit 107 optimizes the information of the parameters used by the feature extraction unit 101 and the class representative vectors stored in the class representative vector memory 102 based on the classification error calculated by the classification error calculation unit 105 and the inter-class distance error calculated by the inter-class distance error calculation unit 106. For example, the optimization unit 107 optimizes the information of the parameters used by the feature extraction unit 101 and the class representative vectors stored in the class representative vector memory 102 based on the classification error and the inter-class distance error such that the areas of the feature values of the classes do not overlap each other in the feature space.

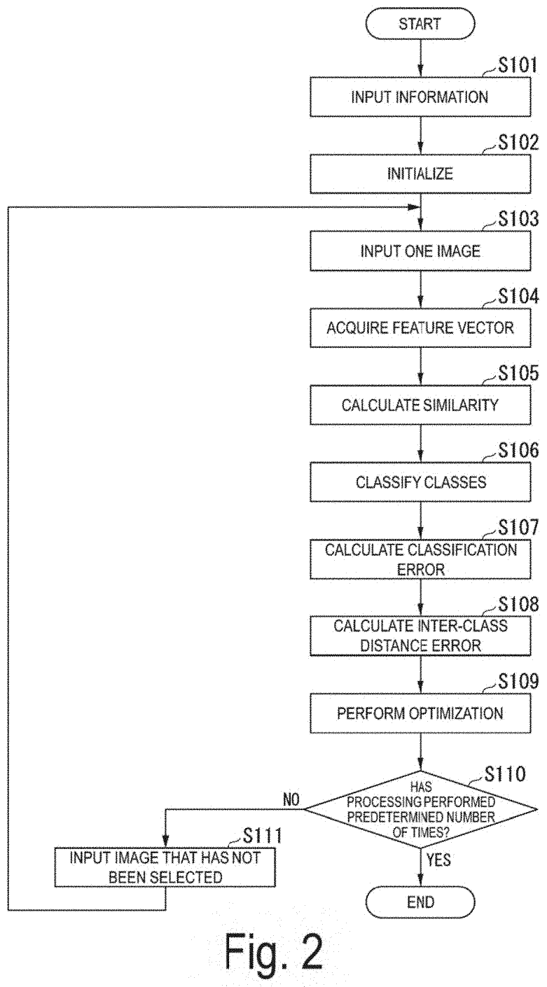

FIG. 2 is a flowchart illustrating processing of the parameter optimization apparatus 10 according to the embodiment.

The parameter optimization apparatus 10 receives input of, as training data, the input image xᵢ (i is an integer equal to or greater than 1), correct answer data yᵢ, and information of the number of classification classes K (step S101). The input image xᵢ is input to the feature extraction unit 101, the correct answer data yᵢ is input to the classification error calculation unit 105, and the information of the number of classification classes K is input to the initialization unit 100. The initialization unit 100 sets the class representative vectors to vectors Wₖ (0≤k<K), and initializes the parameters used by the feature extraction unit 101 and the vectors Wₖ into random values (step S102). The initialized or optimized class representative vectors are denoted as Wₖ′.

The feature extraction unit 101 receives input of the input image xᵢ (step S103). For example, when a plurality of input images are input, one input image is selected and input to the feature extraction unit 101. The feature extraction unit 101 acquires a feature vector fᵢ′ of the input image xᵢ using the input image xᵢ (step S104). The feature extraction unit 101 outputs the extracted feature vector fᵢ′ to the similarity calculation unit 103.

The similarity calculation unit 103 receives input of the feature vector fᵢ′ output from the feature extraction unit 101 and each of the class representative vectors Wₖ′ stored in the class representative vector memory 102. The similarity calculation unit 103 normalizes the input feature vector fᵢ′ and the class representative vectors Wₖ′ with the L2 norm.

In this way, the similarity calculation unit 103 acquires the normalized feature vector fᵢ and each of the normalized class representative vectors Wₖ. Then, the similarity calculation unit 103 calculates a similarity cₖ between the acquired feature vector fᵢ and each class representative vector Wₖ (step S105). For example, the similarity calculation unit 103 calculates the similarity cₖ for each class representative vector based on Equation 1 below.

[Math. 1]

cₖ=fᵢ·Wₖ Equation (1)

The symbol “⋅” in Equation (1) represents a scalar product. In this manner, the similarity calculation unit 103 calculates the similarity cₖ by calculating the acquired scalar product of the feature vector fᵢ and each class representative vector Wₖ. The similarity calculation unit 103 outputs information of the similarity cₖ for each calculated class representative vector to the classification unit 104.

The classification unit 104 acquires the classification result using the softmax function and the similarity cₖ for each class representative vector (step S106). Specifically, the classification unit 104 applies the similarity cₖ for each class representative vector to the softmax to acquire the classification result indicating the probability of the feature vector fᵢ belonging to each class. The classification unit 104 outputs information indicating the acquired classification result to the classification error calculation unit 105.

The classification error calculation unit 105 calculates a classification error L_{c} using the information indicating the classification result and the input correct answer data (step S107). For example, the classification error calculation unit 105 calculates a cross-entropy to calculate the classification error. The classification error calculation unit 105 outputs the calculated classification error L_{c} to the optimization unit 107.

The inter-class distance error calculation unit 106 calculates an error L_{d} of the distance between the class representative vectors stored in the class representative vector memory 102 (step S108). Specifically, the inter-class distance error calculation unit 106 calculates the inter-class distance error L_{d} based on Equation (2) below.

$$[ Math . 2 ]$$

$${L}_{d} = {max}_{m < n} ( {W}_{m} \cdot {W}_{n} ) \qquad Equation ( 2 )$$

In Equation (2), m and n are values equal to or greater than 0 and integers satisfying 0≤m and n<K. The inter-class distance error calculation unit 106 outputs the calculated inter-class distance error L_{d} to the optimization unit 107. The optimization unit 107 receives input of the classification error L_{c} and the inter-class distance error L_{d}. The optimization unit 107 solves a minimization problem of the objective function of Equation (3) below using the input classification error L_{c} and inter-class distance error L_{d} and thereby updates the information of the parameters used by the feature extraction unit 101 and the class representative vectors stored in the class representative vector memory 102 (step S109).

[Math. 3]

L=L_{c} const. L_{d}<d Equation (3)

Here, as an optimization method performed by the optimization unit 107, there are two methods (a first method and a second method).

In the first method, the optimization unit 107 first updates the class representative vectors to satisfy the relationship of the inter-class distance error L_{d}<d. For example, the optimization unit 107 updates the class representative vectors to optimize the objective function of L=L_{d}−d using a gradient method. Here, d is a predetermined integer. Next, the optimization unit 107 optimizes the objective function L=L_{c} using the gradient method with the class representative vectors fixed. That is, in the first method, after a position of the class representative vector of each class on the feature space is determined, the classification error is optimized using the gradient method, and thereby the parameters used by the feature extraction unit 101 are optimized.

Due to the above processing, the parameters used by the feature extraction unit 101 are optimized such that the distances between multiple classes serving as classification destinations in the feature space are uniform. Furthermore, the feature value extracted by the feature extraction unit 101 is mapped to any of areas of the multiple classes in the feature space.

In the second method, the optimization unit 107 uses the method of Lagrange multiplier to optimize the objective function L=L_{c}+λL_{d} (λ is a Lagrange coefficient) using the gradient method. That is, in the second method, the distance error between the class representative vectors is applied to the classification error and optimization is performed using the gradient method, so that the parameters used by the feature extraction unit 101 are optimized. For example, the distance error between the class representative vectors used in the second method is the maximum value of the distances between all classes.

The optimization unit 107 determines whether processing from step S103 to step S109 has been performed a predetermined number of times (step S110). If the processing has been performed the predetermined number of times (YES in step S110), the parameter optimization apparatus 10 ends the processing of FIG. 2.

On the other hand, if the processing has not been performed the predetermined number of times (NO in step S110), the feature extraction unit 101 receives input of an input image that has not been selected (step S110). Then, the parameter optimization apparatus 10 executes the processing from step S103.

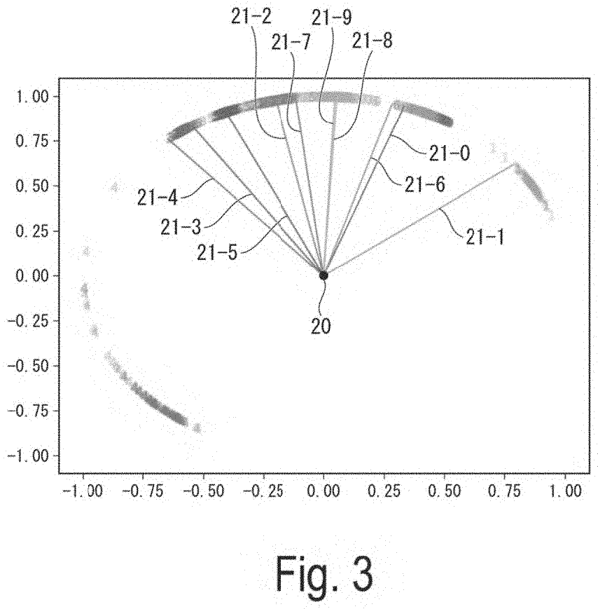

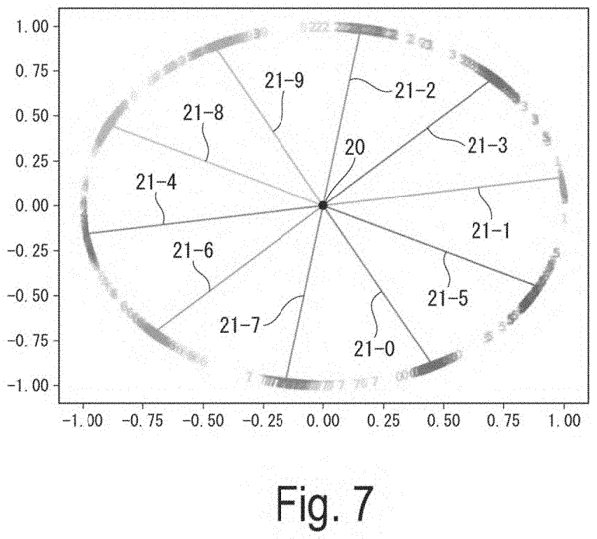

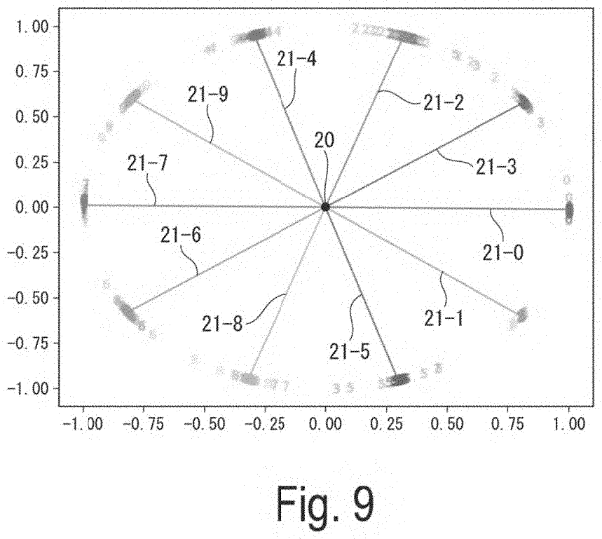

Test results of techniques of the related art and test results of the present disclosure and a combination of the techniques of the related art with the technique of the present disclosure will be described with reference to FIGS. 3 to 14. In each of FIGS. 3 to 14, an example is shown in which L2-Constrained Softmax Loss or ArcFace is used as a technique of the related art. FIGS. 3 to 6 are diagrams showing the test results of the technique of the related art, FIGS. 7, 8, 11, and 12 show the test results of the present disclosure, and FIGS. 9, 10, 13, and 14 are graphs showing the test results when the technique of the related art (ArcFace) is combined with the technique of the present disclosure. In the tests, feature vectors are expressed in two dimensions using the 10 classes of the Modified National Institute of Standards and Technology (MNIST) dataset.

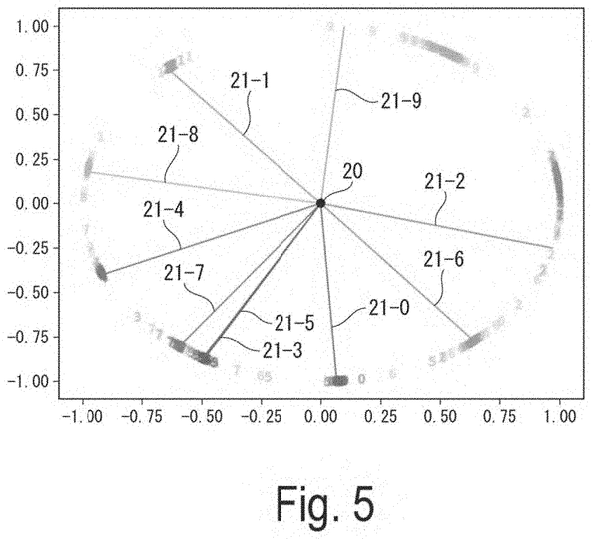

In the example shown in FIG. 3, L2-Constrained Softmax Loss is used as a technique of the related art, and an example in which feature vectors immediately before the final layer are visualized on a hypersphere is shown. In FIG. 3, each of the multiple straight lines 21-0 to 21-9 extending outward from the position of the center 20 represents a class representative vector of its class, and the numbers corresponding to the straight lines 21-0 to 21-9 represent sample data. Further, reference numerals in FIGS. 5, 7, 9, 11, and 13 represent the same matters as those of the reference numerals in FIG. 3.

For example, the straight line 21-0 represents a class representative vector of the class of the number “0”. The straight line 21-1 represents a class representative vector of the class of the number “1”. The straight line 21-2 represents a class representative vector of the class of the number “2”. The straight line 21-3 represents a class representative vector of the class of the number “3”. The straight line 21-4 represents a class representative vector of the class of the number “4”. The straight line 21-5 represents a class representative vector of the class of the number “5”. The straight line 21-6 represents a class representative vector of the class of the number “6”. The straight line 21-7 represents a class representative vector of the class of the number “7”. The straight line 21-8 represents a class representative vector of the class of the number “8”. The straight line 21-9 represents a class representative vector of the class of the number “9”.

It is ascertained that, when L2-Constrained Softmax Loss is used, the class representative vectors of similar sample data are mapped at close positions on the hypersphere as shown in FIG. 3.

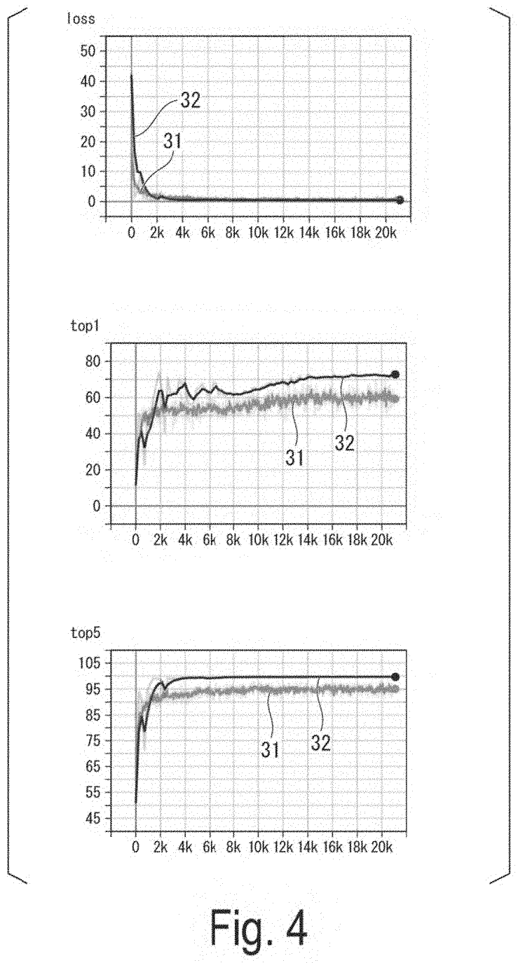

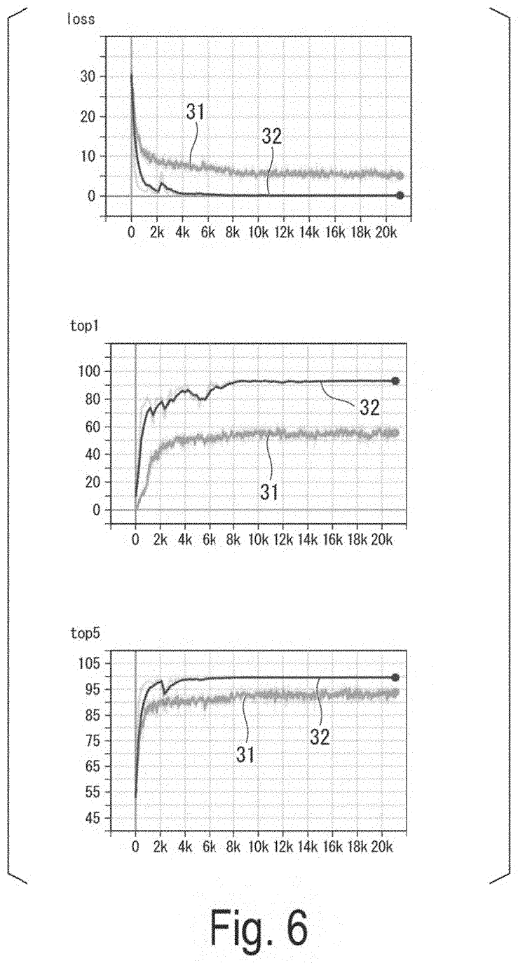

FIG. 4 shows the results of loss and the classification accuracy when L2-Constrained Softmax Loss is used as a technique of the related art. In FIG. 4, line 31 represents the result when training data is used, and line 32 represents the result when test data is used. Further, reference numerals in FIGS. 6, 7, 10, 12, and 14 represent the same matters as those of the reference numerals in FIG. 4.

In the example shown in FIG. 5, ArcFace is used as a technique of the related art, and an example in which feature vectors immediately before the final layer are visualized on a hypersphere is shown. FIG. 6 shows the results of loss and the classification accuracy when ArcFace is used as a technique of the related art. It is ascertained that, although the degree of the problem is smaller when ArcFace is used than when L2-Constrained Softmax Loss is used, the entire feature space is not able to be fully utilized because “3” and “5” are mapped to approximately the same position, or “9” and “2” are apart from each other as shown in FIG. 5.

It is ascertained that classification accuracy of similar classes decreases in the technique of the related art as seen in FIGS. 3 to 6. For example, the classification accuracy when L2-Constrained Softmax Loss is used is 70%, and the classification accuracy when ArcFace is used is approximately 90%. Furthermore, the entire feature space is not fully utilized in the technique of the related art.

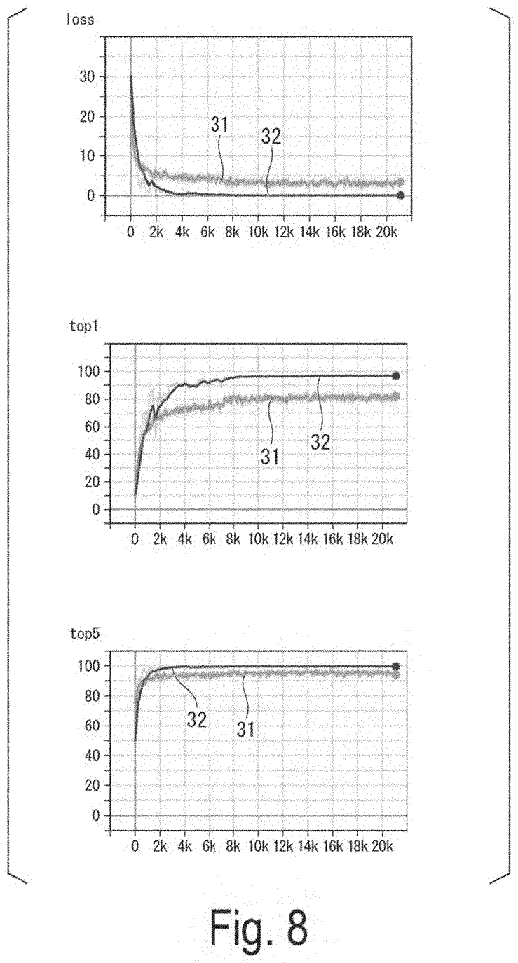

FIG. 7 shows an example in which the feature vectors immediately before the final layer are visualized on a hypersphere using the first technique of the present disclosure. FIG. 8 shows the results of loss and the classification accuracy when the first technique of the present disclosure is used.

It is ascertained that each of the classes is separated when the first technique of the present disclosure is used and that the entire feature space is able to be fully utilized as shown in FIG. 7, compared to when L2-Constrained Softmax Loss is used.

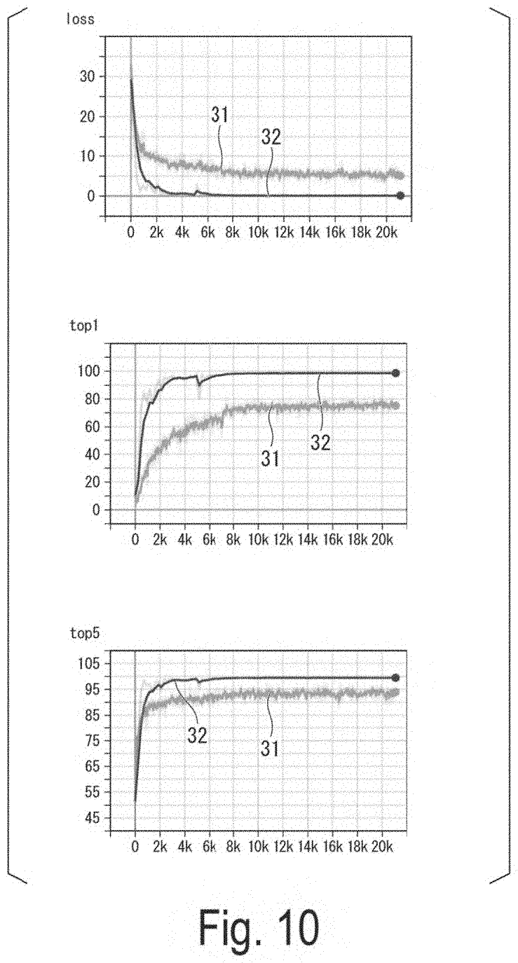

FIG. 9 shows an example in which the feature vectors immediately before the final layer are visualized on a hypersphere using the combination of the first technique of the present disclosure with ArcFace. FIG. 10 shows the results of loss and the classification accuracy when the combination of the first technique of the present disclosure with ArcFace is used.

It is ascertained that each of the classes is separated and that the entire feature space is able to be fully utilized as shown in FIG. 9 when the combination of the first technique of the present disclosure with ArcFace is used, compared to when ArcFace is solely used.

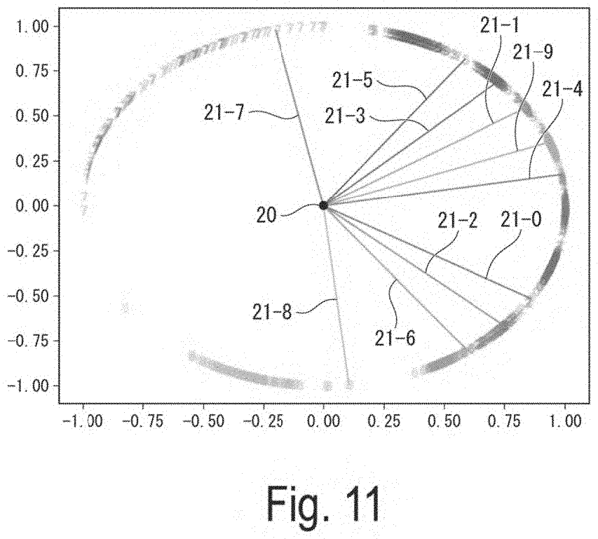

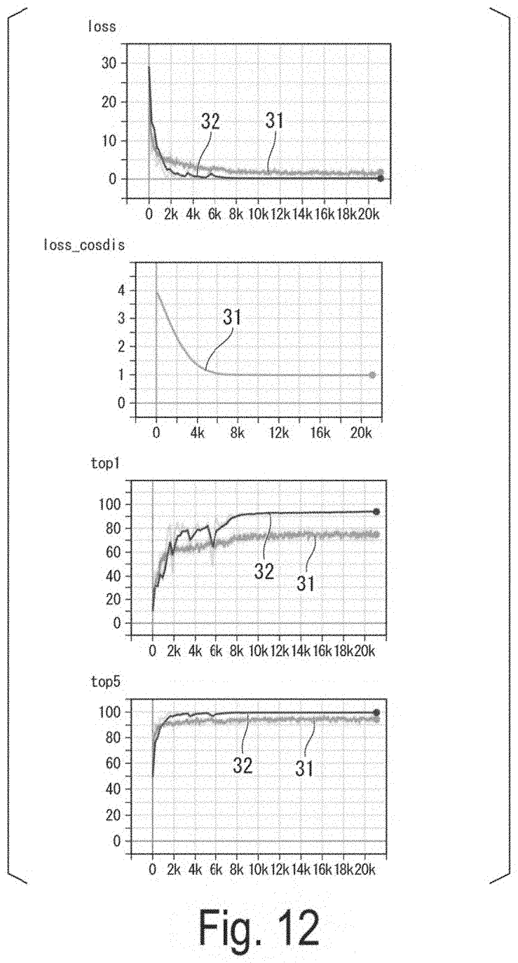

FIG. 11 shows an example in which the feature vectors immediately before the final layer are visualized on a hypersphere using the second technique of the present disclosure. FIG. 12 shows the results of loss and the classification accuracy when the second technique of the present disclosure is used.

It is ascertained that the classification accuracy is improved when the second technique of the present disclosure is used, compared to when L2-Constrained Softmax Loss is used as shown in FIG. 11.

Specifically, while data having similar features is more likely to be mapped at close positions in the feature space in L2-Constrained Softmax Loss, learning in the second method of the present disclosure is explicitly performed such that the gaps between the class representative vectors are widened. As a result, the data having similar features is prevented from being mapped at close positions in the feature space. Therefore, the classification accuracy can be improved.

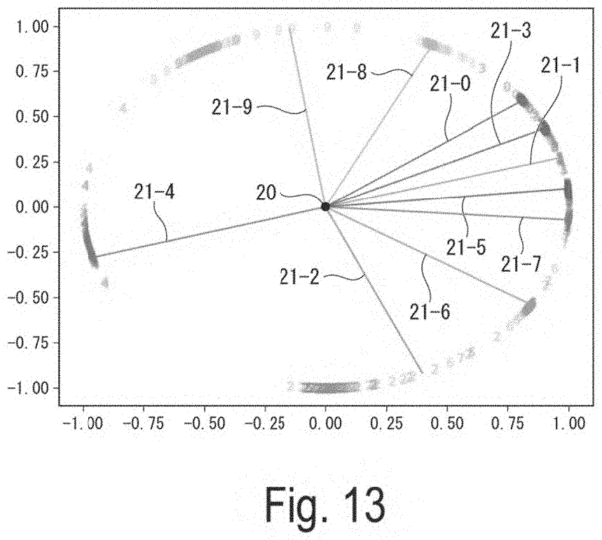

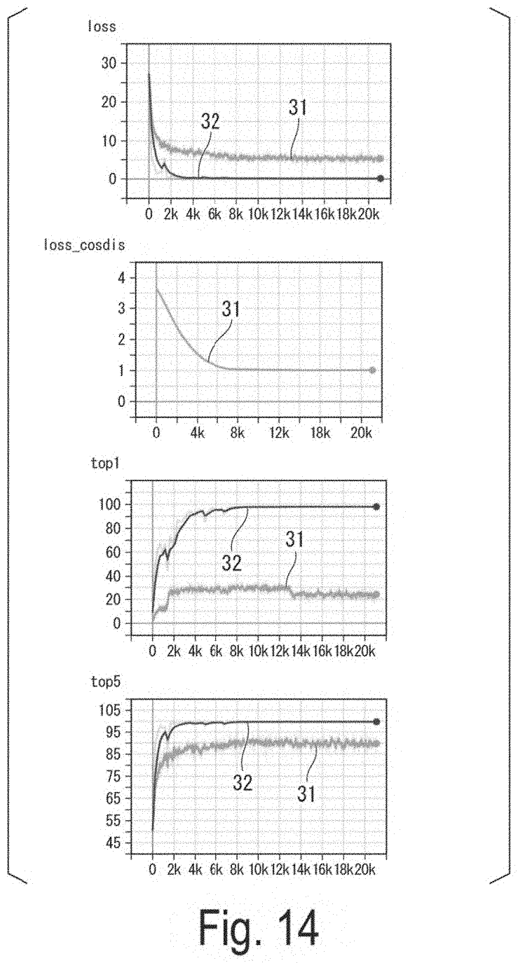

FIG. 13 shows an example in which the feature vectors immediately before the final layer are visualized on a hypersphere using the combination of the second technique of the present disclosure with ArcFace. FIG. 14 shows the results of loss and the classification accuracy when the combination of the second technique of the present disclosure with ArcFace is used. It is ascertained that the classification accuracy is improved as shown in FIG. 13 when the combination of the second technique of the present disclosure with ArcFace is used, compared to when ArcFace is solely used.

Specifically, while data having similar features is more likely to be mapped at close positions in the feature space in ArcFace, learning in the second method of the present disclosure is explicitly performed such that the gaps between the class representative vectors are widened. As a result, the data having similar features is prevented from being mapped at close positions in the feature space. Therefore, the classification accuracy can be improved.

The parameter optimization apparatus 10 configured as described above extracts a feature vector using input data, acquires a classification result of the feature vector and a class representative vector of every class serving as a classification target, and optimizes a parameter based on a classification error obtained using correct answer data and the classification result and a distance error between the class representative vectors such that the areas of features of the respective classes do not overlap each other in a feature space. Thus, optimization can be achieved such that the distances between the classes are maximized, that is, the cosine similarity is reduced. As a result, the classification accuracy can be improved.

In the first method for optimization, the parameter optimization apparatus 10 optimizes the parameters after a position of the class representative vector of each class in the feature space is determined and the classification error is optimized using the gradient method. More specifically, the class representative vectors are mapped in advance to be evenly spaced in the feature space. Thus, optimization can be achieved such that the distances between the classes are maximized, that is, the cosine similarity is reduced. As a result, the classification accuracy can be improved.

In the second method for optimization, the parameter optimization apparatus 10 optimizes the parameters by applying as a penalty the distance error between the class representative vectors to the classification error and optimization is performed using the gradient method. At this time, the parameter optimization apparatus 10 uses the method of Lagrange multiplier. Thus, optimization can be achieved such that the distances between the classes are maximized, that is, the cosine similarity is reduced. As a result, the classification accuracy can be improved.

In the present disclosure, there is room for entry of a new class in the feature space when a new class is learned again, and thus improvement in accuracy of machine learning such as Zero Shot Learning can also be expected.

The first method is a method for the task of class classification because classes are mapped to be forcibly evenly spaced without considering the proximity of similar classes. The second method is a technique for the task of abnormality detection because the technique still retains a factor of distance learning to make similar classes close to each other.

### Modified Example

In the above-described embodiment, the parameter optimization apparatus 10 has a configuration in which whether the processing from step S103 to step S108 has been performed the predetermined number of times is determined in the processing of step S109. The parameter optimization apparatus 10 may be configured to determine in the processing of step S109 whether the processing from step S103 to step S108 has been performed until the values of the parameters used by the feature extraction unit 101 and the class representative vectors converge. When configured as described above, if the values of the parameters and the class representative vectors do not converge (NO in step S109), the feature extraction unit 101 receives input of an input image that has not been selected (step S110). Then, the parameter optimization apparatus 10 executes the processing from step S103. On the other hand, if the values of the parameters and the class representative vectors converge (YES in step S109), the parameter optimization apparatus 10 ends the processing of FIG. 2. With the above configuration, the processing is performed until optimization is achieved, and thus classification accuracy can be further improved.

A method for calculating an inter-class distance error L_{d} need not be limited to Equation (2) above. For example, an inter-class distance error L_{d} may be calculated using the following Equation (4) or (5). Equation (4) is based on the sum of all distances of class representative vectors. Equation (5) is based on the sum of class maximum distances.

$$[ Math . 4 ]$$

$${L}_{d} = {\sum }_{n = 0}^{K - 1} {\sum }_{m = n + 1}^{K - 1} {W}_{n} \cdot {W}_{m} \qquad Equation ( 4 )$$

$$[ Math . 5 ]$$

$$\begin{matrix}{L}_{d} = {\sum }_{n = 0}^{K - 1} max ( {\sum }_{m = 0}^{K - 1} {W}_{n} \cdot {W}_{m} ) & ( Where , m \neq n )\end{matrix} \qquad Equation ( 5 )$$

Some or all of the functional units of the above-described parameter optimization apparatus 10 may be implemented by a computer. In that case, the functions may be implemented by recording a program for implementing the functions in a computer readable recording medium and causing a computer system to read and execute the program recorded in the recording medium. Note that the “computer system” described here is assumed to include an OS and hardware such as a peripheral device. The “computer-readable recording medium” means a portable medium such as a flexible disk, a magneto-optical disk, a ROM, or a CD-ROM or a storage device such as a hard disk incorporated in the computer system.

Moreover, the “computer-readable recording medium” may include a recording medium that dynamically holds the program for a short period of time, such as a communication line in a case in which the program is transmitted via a network such as the Internet or a communication line such as a telephone line, or a recording medium that holds the program for a specific period of time, such as a volatile memory inside a computer system that serves as a server or a client in that case. Furthermore, the aforementioned program may be for implementing some of the aforementioned functions, or may be able to implement the aforementioned functions in combination with a program that has already been recorded in the computer system, or using a programmable logic device such as a field programmable gate array (FPGA).

Although the embodiments of the present disclosure have been described in detail with reference to the drawings, a specific configuration is not limited to the embodiments, and a design or the like in a range that does not depart from the gist of the present disclosure is included.

### INDUSTRIAL APPLICABILITY

The present disclosure can be applied to techniques for classification into classes.

### REFERENCE SIGNS LIST

10 Parameter optimization apparatus
100 Initialization unit
101 Feature extraction unit
102 Class representative vector memory
103 Similarity calculation unit
104 Classification unit
105 Classification error calculation unit
106 Inter-class distance error calculation unit
107 Optimization unit

1. A parameter optimization method comprising:
extracting a feature vector using input data;
acquiring a classification result of the feature vector and a class representative vector of every class serving as a classification target; and
optimizing a parameter used in the extracting based on a classification error obtained using correct answer data and the classification result and a distance error between the class representative vectors such that areas of features of the classes in a feature space do not overlap each other.

2. The parameter optimization method according to claim 1, wherein
in the optimizing, a position of the class representative vector of every class in the feature space is determined and then the classification error is optimized using a gradient method, so that the parameter is optimized.

3. The parameter optimization method according to claim 1, wherein
in the optimizing, the distance error between the class representative vectors is applied to the classification error and optimization is performed using a gradient method, so that the parameter is optimized.

4. A non-transitory recording medium configured to record a computer program for causing a computer to execute the parameter optimization method according to claim 1.

5. A feature extraction method comprising:
acquiring target data to be classified; and
extracting a feature from the target data, wherein
in the extracting, optimization is performed such that distances between a plurality of classes serving as classification destinations in a feature space are uniform, and the feature is mapped to an area of any of the plurality of classes in the feature space.

6. A parameter optimization apparatus comprising:
a feature extractor configured to extract a feature vector using input data;
a classificater configured to acquire a classification result of the feature vector and a class representative vector of every class serving as a classification target; and
an optimizer configured to optimize a parameter used in the feature extractor based on a classification error obtained using correct answer data and the classification result and a distance error between the class representative vectors such that areas of features of the classes in a feature space do not overlap each other.

7. A parameter optimization method comprising:
extracting a feature vector using input data;
acquiring a classification result of the feature vector and a class representative vector of every class serving as a classification target; and
optimizing a parameter used in the extracting based on a classification error obtained using correct answer data and the classification result and a distance error between the class representative vectors, wherein
in the optimizing, a position of the class representative vector of every class in the feature space is determined and then the classification error is optimized using a gradient method, so that the parameter is optimized.

8. A parameter optimization method comprising:
extracting a feature vector using input data;
acquiring a classification result of the feature vector and a class representative vector of every class serving as a classification target; and
optimizing a parameter used in the extracting based on a classification error obtained using correct answer data and the classification result and a distance error between the class representative vectors, wherein
in the optimizing, the distance error between the class representative vectors is applied to the classification error and optimization is performed using a gradient method, so that the parameter is optimized.
